(19) United States
(12) Patent Application Publication
(10) Pub. No.: US 2003/0026338 A1
(43) Pub. Date: Feb. 6, 2003

(54) Automated mask selection in object-based video encoding

(75) Inventor: Yong Yan, Yorktown Heights, NY (US)

Correspondence Address: Corporate Patent Counsel, Philips Electronics North America Corporation, 580 White Plains Road, Tarrytown, NY, 10591, US

(73) Assignee: Koninklijke Philips Electronics N.V.

(21) Appl. No.: 09/922,142

(22) Filed: Aug. 3, 2001

(51) Int. Cl. H04N 7/12

(52) U.S. Cl. 375/240.08; 375/240.24

(57) ABSTRACT

A video object encoding system and method that dynamically selects a mask type based on the characteristics of the video object. The system comprises an object evaluation system that evaluates a video object using a predetermined criterion; and a mask generation system that generates one of a plurality of mask types for the video object based on the evaluation of the video object.

### BACKGROUND OF THE INVENTION

1. Technical Field

The present invention relates to object-based coding for video communication systems, and more particularly relates to a system and method for selecting masks in an object-based coding environment.

2. Related Art

With the advent of personal computing and the Internet, a huge demand has been created for the transmission of digital data, and in particular, digital video data. However, the ability to transmit video data over low capacity communication channels, such as telephone lines, remains an ongoing challenge.

To address this issue, systems are being developed in which coded representations of video signals are broken up into video elements or objects that can be independently encoded and manipulated. For example, MPEG-4 is a compression standard developed by the Moving Picture Experts Group (MPEG) that operates on video objects. Each video object is characterized by temporal and spatial information in the form of shape, motion and texture information, which are coded separately.

Instances of video objects in time are called video object planes (VOP). Using this type of representation allows enhanced object manipulation, bit stream editing, object-based scalability, etc. Each VOP can be fully described by texture and shape representations. The shape information can be represented as a binary shape mask, the alpha plane, or a gray-scale shape for transparent objects.

In order to capture video objects in the alpha plane for encoding, shape masks are used that match or approximate the shape of the object. Commonly used masks in the alpha plane for object-based coding include: (1) an arbitrary shape that closely matches the object on a pixel level (i.e., a pixel-based mask); (2) a bounding box that bounds the object shape (e.g., a rectangle); or (3) a macroblock-based mask. Depending on the shape and complexity of the object, bit rate requirements for implementing each mask type may vary. Moreover, while one type of mask may require fewer bits for shape coding, the same mask type may result in a higher number of bits required for texture coding.

Accordingly, a need exists for a system that can automatically select the best mask in order maximize bit rate savings.

### SUMMARY OF THE INVENTION

The present invention addresses the above-mentioned needs, as well as others, by providing a video object encoding system that dynamically chooses the best mask based on the actual characteristics (i.e., the coded shape, texture and motion information) of the object. In a first aspect, the invention provides a video object encoding system, comprising: an object evaluation system that evaluates a video object using a predetermined criterion; and a mask generation system that generates one of a plurality of mask types for the video object based on the evaluation of the video object.

In a second aspect, the invention provides a program product stored on a recordable medium, which when executed, encodes video objects, the program product comprising: program code configured to evaluate a video object using a predetermined criterion; and program code configured to generate one of a plurality of mask types for the video object based on the evaluation of the video object.

In a third aspect, the invention provides a method for encoding video objects in an object based video communication system, comprising the steps of: evaluating a video object using a predetermined criterion; and generating one of a plurality of mask types for the video object based on the evaluation of the video object.

### BRIEF DESCRIPTION OF THE DRAWINGS

The preferred exemplary embodiment of the present invention will hereinafter be described in conjunction with the appended drawings, where like designations denote like elements, and:

FIG. 1 depicts a functional diagram of an object encoding system in accordance with a preferred embodiment of the present invention.

FIG. 2 depicts an exemplary shape criterion flow diagram in accordance with the invention.

### DETAILED DESCRIPTION OF THE INVENTION

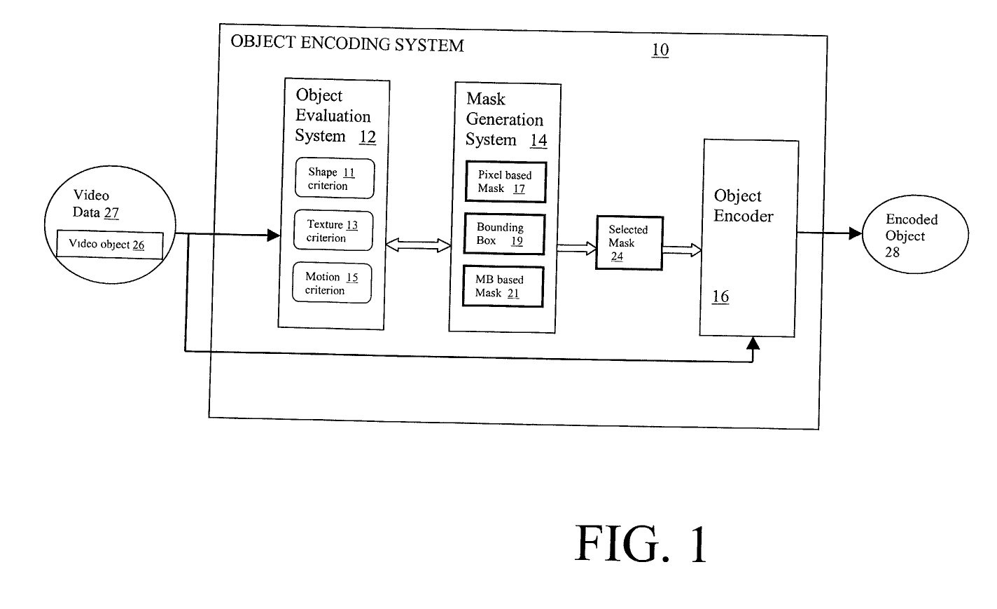

Referring now to the figures, FIG. 1 depicts an object encoding system 10 that encodes a video object 26 from video data 27 into an encoded object 28. The video object is isolated from the video data using a mask of a type selected from a plurality of mask types by object encoding system 10. In order to select an appropriate mask type, object encoding system 10 includes an object evaluation system 12 for evaluating characteristics of the video object, a mask generation system 14 for creating a mask of the selected type, and an object encoder 16 for encoding the video object using the created mask. It should be understood that object encoding system 10 could be implemented as a stand-alone system, or could be incorporated into a larger system, such as an MPEG-4 encoder.

According to this preferred embodiment, any one of several different mask types 17, 19, 21 may be utilized for the encoding process. Object encoding system 10 determines the best type of mask to be generated for the inputted video object 26 based on the characteristics of the video object 26. In order to determine the best mask type to be utilized, object evaluation system 12 provides one or more criterions 11, 13, 15 that can be used to evaluate the characteristics of the video object. In the embodiment depicted in FIG. 1, object evaluation system 12 provides three different categories of criterions, including a shape criterion 11, a texture criterion 13, and a motion criterion 15. Thus, when a video object 26 requires encoding, its shape, texture and/or motion characteristics can be evaluated by shape evaluation system 12, and based on that evaluation, a mask type is selected.

Shape criterion 11, texture criterion 13 and motion criterion 15 provide templates or guidelines that help to classify the video object 26. Based on the classification, the best type of mask to encode the object can be selected and then generated by mask generation system 14. For example, if shape criterion 11 were used to evaluate the video object 26, then the shape information coded into video object 26 would be evaluated to classify the object (e.g., substantially round, substantially square, etc.). Once the shape is classified, an appropriate mask type can be used to provide a desired result, i.e., some predetermined balance of bit rate efficiency and representation accuracy. Similarly, if texture criterion 13 were used, the texture information coded into video object 26 would be evaluated and if motion criterion 15 were used, the motion information coded into video object 26 would be evaluated. It should be understood that other criterions could likewise be utilized and such other criterions are believed to fall within the scope of this invention.

Mask generation system 14 generates the appropriate mask type based on the results of object evaluation system 12. In the embodiment depicted in FIG. 1, three exemplary mask types are shown, including a pixel-based mask 17, a bounding box mask 19 and a macroblock-based mask 21. Each of these mask types, as well as others not shown herein, provide different levels of bit rate efficiency and representation accuracy. Thus, the different mask types can be used to achieve different predetermined performance requirements. It is understood that each of the mask types described in FIG. 1 are well known in the art and therefore not described in further detail.

After mask generation system 14 selects the best mask type to achieve the desired result, the selected mask 24 is generated and provided to object encoder 16, which receives video object 26, encodes the object, and outputs an encoded object 28. The process of encoding objects using masks (e.g., as taught under MPEG-4) is also well known in the art, and therefore is not discussed in detail.

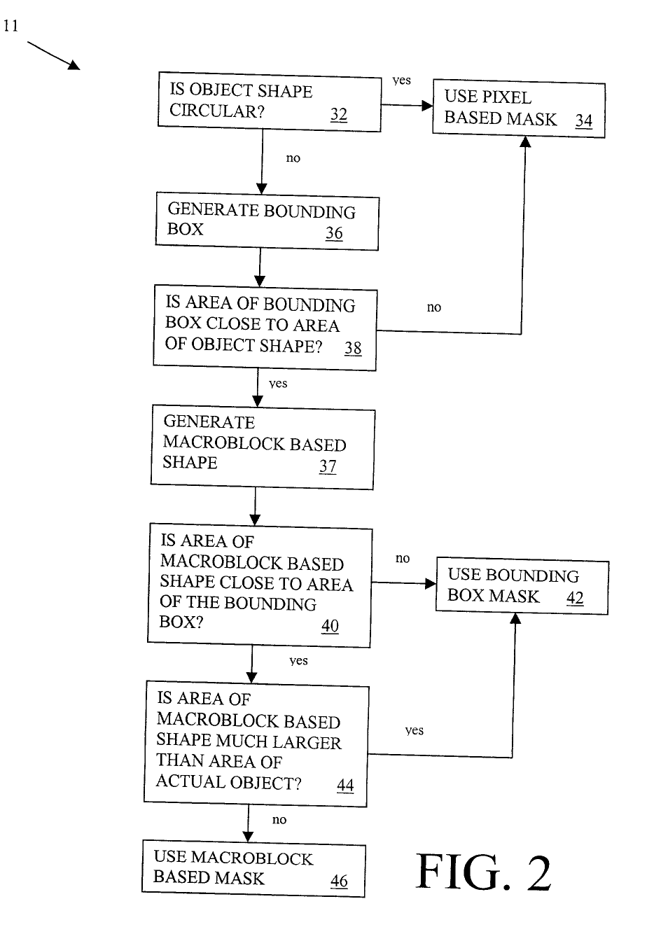

Referring now to FIG. 2, an exemplary shape criterion 11 is shown for evaluating a video object and selecting a mask type. In this exemplary case, the first step is to determine if the object shape is substantially circular 32. If the shape is substantially circular, then a pixel-based mask is used 34. If the object shape is not substantially circular, then a bounding box (i.e., a rectangular box that captures the object) is generated 36. Next, it is determined if the area of the generated bounding box is substantially close to the area of the object shape 38. If the area of the bounding box is not substantially close to the area of the object shape, then a pixel-based mask is used 34. If it is substantially close, then a macroblock-based shape (i.e., a collection of 16×16 pixel blocks that capture the object) is generated 37.

Next, a determination is made as to whether the area of the generated macroblock-based shape is substantially close to the area of the bounding box 40. If it is not substantially close, then a bounding box mask 42 is used. If it is substantially close, then a determination is made as to whether the area of the macroblock-based shape is substantially larger than the area of the actual object 44. If it is substantially larger, then the bounding box mask is used 42. If it is not substantially larger, then a macroblock-based mask is used 46.

It should be understood that the logic depicted in FIG. 2 provides one of many possible criterions that could be used to evaluate the shape of an object.

It is also understood that the systems, functions, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention have been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A video object encoding system, comprising:
an object evaluation system that evaluates a video object using a predetermined criterion; and
a mask generation system that generates one of a plurality of mask types for the video object based on the evaluation of the video object.

2. The video object encoding system of claim 1, wherein the plurality of mask types includes a pixel-based mask, a bounding box mask, and a macroblock-based mask.

3. The video object encoding system of claim 1, wherein the predetermined criterion examines a shape of the video object.

4. The video object encoding system of claim 1, wherein the predetermined criterion examines a texture of the video object.

5. The video object encoding system of claim 1, wherein the predetermined criterion examines motion information regarding the video object.

6. The video object encoding system of claim 3, wherein the predetermined criterion includes whether the video object shape is substantially circular.

7. The video object encoding system of claim 3, wherein the predetermined criterion includes whether an area of the video object shape is substantially similar to an area of a generated bounding box.

8. The video object encoding system of claim 7, wherein the predetermined criterion includes whether an area of a macroblock-based shape generated for the video object is substantially similar to the area of the generated bounding box.

9. The video object encoding system of claim 8, wherein the predetermined criterion includes whether the area of a macroblock-based shape is larger than the area of the video object shape.

10. The video object encoding system of claim 1, further comprising an MPEG-4 encoder.

11. A program product stored on a recordable medium, which when executed, encodes video objects, the program product comprising:
program code configured to evaluate a video object using a predetermined criterion; and
program code configured to generate one of a plurality of mask types for the video object based on the evaluation of the video object.

12. The program product of claim 11, wherein the plurality of mask types includes a pixel-based mask, a bounding box mask, and a macroblock-based mask.

13. The program product of claim 11, wherein the predetermined criterion examines a shape of the video object.

14. The program product of claim 11, wherein the predetermined criterion examines a texture of the video object.

15. The program product of claim 11, wherein the predetermined criterion examines motion information regarding the video object.

16. The program product of claim 13, wherein the predetermined criterion includes whether the video object shape is substantially circular.

17. The program product of claim 13, wherein the predetermined criterion includes whether an area of the video object shape is substantially similar to an area of a generated bounding box.

18. The program product of claim 17, wherein the predetermined criterion includes whether an area of a macroblock-based shape generated for the video object is substantially similar to the area of the generated bounding box.

19. The program product of claim 18, wherein the predetermined criterion includes whether the area of a macroblock-based shape is larger than the area of the video object shape.

20. A method for encoding video objects in an object based video communication system, comprising the steps of:
evaluating a video object using a predetermined criterion; and
generating one of a plurality of mask types for the video object based on the evaluation of the video object.

21. The method of claim 20, wherein the plurality of mask types includes a pixel-based mask, a bounding box mask, and a macroblock-based mask.

22. The method of claim 20, wherein the predetermined criterion examines a shape of the video object.

23. The method of claim 20, wherein the predetermined criterion examines a texture of the video object.

24. The method of claim 20, wherein the predetermined criterion examines motion information regarding the video object.

25. The method of claim 22, wherein the evaluating step includes determining if the shape is substantially circular.

26. The method of claim 22, wherein the evaluating step includes:
generating a bounding box; and
determining if an area of the object shape is substantially similar to an area of the generated bounding box.

27. The method of claim 26, wherein the evaluating step includes:
generating a macroblock-based shape; and
determining whether an area of the macroblock-based shape is substantially similar to the area of the generated bounding box.

28. The method of claim 27, wherein the evaluating step includes determining whether the area of a macroblock-based shape is larger than the area of the object shape.
